(19) United States
(12) Patent Application Publication
(10) Pub. No.: US 2014/0067571 A1
(43) Pub. Date: Mar. 6, 2014

(54) ENHANCED DATA EXCHANGE BETWEEN MOBILE DEVICE AND MERCHANT SYSTEM

(71) Applicants: Andreas Schlosser, Weiterstadt (DE); Thomas Fricke, Alzey (DE); Markus Hueck, Bonn (DE)

(72) Inventors: Thomas Fricke, Alzey (DE); Markus Hueck, Bonn (DE); Andreas Schlosser, Weiterstadt (DE)

(21) Appl. No.: 14/014,856

(22) Filed: Aug. 30, 2013

Related U.S. Application Data
(60) Provisional application No. 61/696,438, filed on Sep. 4, 2012.

(51) Int. Cl. G06Q 20/32

(52) U.S. Cl. CPC G06Q 20/327
USPC 705/21

(57) ABSTRACT

A method within a gateway for facilitating a payment portion of a transaction involving a merchant and a user of a wireless device includes receiving at the gateway a first set of information related to the transaction, the first set of information originating from a merchant device and including an identifier of the merchant device and a quanta of value, receiving at the gateway a second set of information related to the transaction, the second set of information originating from the wireless device and including an identifier of the wireless device and the identifier of the merchant device, processing the first and second sets of information, including correlating the first set of information and the second set of information based on at least the identifier of the merchant device, and sending an indicia of authorization based on at least the quanta of value.

This application claims the benefit of U.S. Provisional Application No. 61/696,438, filed Sep. 4, 2012, which is incorporated herein by reference in its entirety.

### TECHNICAL FIELD

The present disclosure relates to wireless device activities. More particularly, the present disclosure relates to capabilities that enhance substantially the value, usefulness, etc. of a Wireless Device (WD) when the WD is used to, among other things, make, facilitate, etc., a payment within a commerce context.

### BACKGROUND

As the ‘wireless revolution’ continues to march forward through various flavors of 2G, 3G, 4G, and beyond, the importance to a Mobile Subscriber (MS)—for example a user of a WD that is serviced by possibly inter alia a Wireless Carrier (WC)—of their WD, grows substantially. Examples of WDs include, possibly inter alia, mobile telephones, handheld computers, Internet-enabled phones, pagers, radios, TVs, audio devices, car audio (and other) systems, recorders, text-to-speech devices, bar-code scanners, net appliances, mini-browsers, Personal Data Assistants (PDAs), etc.

For example, the wireless telecommunications industry trade group, CTIA—The Wireless Association, forecasts that in mid-2011 there were approximately 323 m MSs in the U.S., up from approximately 220 m MSs in the U.S. in mid-2006.

One consequence of such a growing importance to a MS of their WD is the resulting ubiquitous nature of WDs—i.e., MSs carry them at almost all times and use them for an ever-increasing range of activities. In particular, as MSs become increasingly comfortable with the capabilities of their WDs, MSs are beginning to employ their WDs for commercial transactions, including purchases of products and services.

### BRIEF DESCRIPTION OF THE DRAWINGS

The accompanying drawings, which are incorporated herein and form part of the specification, serve to illustrate inter alia the principles, structure, and operation of one or more embodiments described herein. It will be readily apparent to one of ordinary skill in the relevant art that numerous variations, modifications, alternative forms, etc. of the depicted embodiments are easily possible and indeed are within the scope of the claims set forth later herein.

FIG. 1 depicts a networked system including an in-store gateway in accordance with embodiments described herein.

FIG. 2 illustrates portions of a payment transaction that leverage the in-store gateway in accordance with embodiments described herein.

FIG. 3 depicts a flowchart illustrating a process for effectuating a payment transaction using the in-store gateway.

FIG. 4 depicts another flowchart illustrating another process for effectuating a transaction in accordance with embodiments described herein.

FIG. 5 depicts an exemplary computer system through which embodiments described herein may be implemented.

### DESCRIPTION OF EXAMPLE EMBODIMENTS

Overview

In one embodiment there is provided a method operable within a gateway for facilitating a payment portion of a transaction involving a merchant and a user of a wireless device. The method includes receiving at the gateway a first set of information related to the transaction, the first set of information originating from a merchant device and comprising an identifier of the merchant device and a quanta of value, receiving at the gateway a second set of information related to the transaction, the second set of information originating from the wireless device and comprising an identifier of the wireless device and the identifier of the merchant device, processing the first and second sets of information, including correlating the first set of information and the second set of information based on at least the identifier of the merchant device, and sending an indicia of authorization based on at least the quanta of value.

In another embodiment there is provided a method within a wireless device for facilitating a payment portion of a transaction, the transaction comprising a merchant and a user of the wireless device. The method includes: acquiring, using the wireless device, a set of information related to the transaction, the set of information originating from an artifact near a merchant device and comprising an identifier of the merchant device and a destination address, sending, via the wireless device, to the destination address at least an identifier of the wireless device and the identifier of the merchant device, receiving, at the wireless device, a confirmation request message indicative of a quanta of value to be paid to the merchant, and sending, via the wireless device, in response to the confirmation request message, a confirmation message confirming acceptance of the transaction.

### Example Embodiments

The following detailed description refers to the accompanying drawings that illustrate exemplary embodiments. Other embodiments are possible, and modifications can be made to the described embodiments and still be consistent with the principles disclosed herein. Therefore, the following detailed description is not meant to be limiting.

Note that in this description references to “one embodiment” or “an embodiment” mean that the feature being referred to is included in at least one embodiment consistent with the principles described herein. Further, separate references to “one embodiment” in this description do not necessarily refer to the same embodiment; however, neither are such embodiments mutually exclusive, unless so stated and except as will be readily apparent to those skilled in the art.

As noted in the background section above, MSs are employing their WDs for ever increasing activities. For example, MSs employ their WDs to, possibly inter alia:

1) Exchange messages with other MSs (e.g., “Let's meet for dinner at 6”) through Peer-to-Peer (P2P), messaging;

2) Secure information (such as, for example, weather updates, travel alerts, news updates, sports scores, etc.), participate in voting initiatives (such as, for example, with interactive television shows), interact with social networking sites, etc. through various of the available Application-to-Peer (A2P), based service offerings; and

3) Engage in Mobile Commerce (mCommerce, which broadly speaking, encompasses the buying and selling of merchant-supplied products, goods, and services through a WD) and Mobile Banking (“mBanking,” which, broadly speaking, encompasses performing various banking activities through a WD).

Cash, checks, coupons, credit cards, debit cards, pre-paid credit/debit cards, stored value cards, etc. have traditionally been used to complete a payment portion of a transaction (e.g., the purchase of an item at a store, from a vending machine, etc.). However, each of these mechanisms carries with it a range of challenges including, e.g., security issues, and necessity of handling objects (e.g., cards, cash and checks), among other challenges.

Embodiments described herein (1) provide an enhanced mechanism for the exchanging of data between a MS' WD and, e.g., a Merchant's system(s) while possibly inter alia obviating the need for such a Merchant to invest in new equipment (such as, for example, scanner, etc.) while (2) addressing, in new and innovatory ways, various of the not insubstantial challenges that are associated with same.

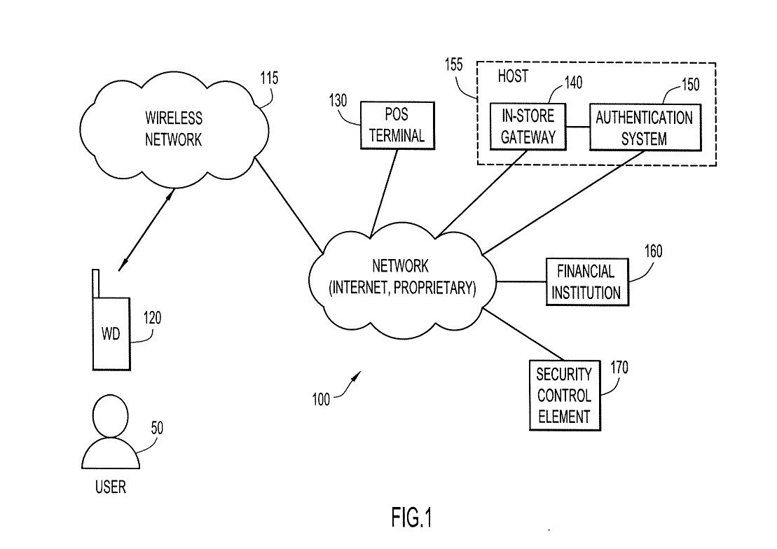

Reference is now made to FIG. 1, which depicts a networked system 100 including several components that together enable the functionality described herein. More specifically, system 100 includes a wireless network 115 that is configured to support one or more of several wireless communication solutions including, cellular, wireless fidelity (WiFi), Bluetooth, near field communications (NFC), etc. The type of wireless network 115 implemented is not critical to embodiments described herein, as long as WD 120 can communicate via such a wireless network. As will be explained more fully below, WD 120 may be used to possibly inter alia scan, photograph, etc. an artifact (such as a bar code, a Quick Response (QR) code, a sign, etc.) near a cash register or the like, and supply the so-captured artifact (or information related thereto) to a downstream element for further processing.

Wireless network 115 is preferentially in communication with a more general electronic network 110, such as the Internet or proprietary electronic network. Also coupled to electronic network 110 are a point of sale (POS) terminal 130, an in-store gateway 140, an authenticating system 150, a financial institution 160 and a security control element 170.

POS terminal 130 may be configured as a payment system, coupon system, cash register, computer, Parking station, vending machine, ticketing system, fuel station (pay-at-the-pump), etc. that possibly inter alia is operated by a merchant, seller or vendor.

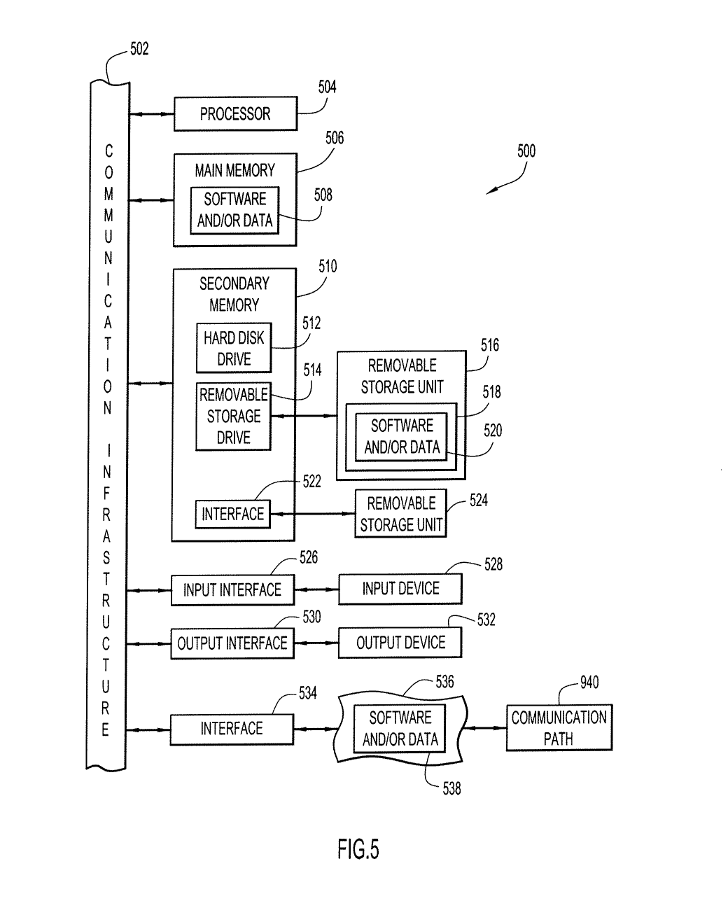

In-store gateway 140 (or simple “gateway”) may be configured as a general purpose computer, server, etc. (like that consistent with the hardware depicted in FIG. 5) and may be deployed, physically, in a commercial/store (“store”) environment or in such a manner that is accessible from the store environment. In-store gateway 140, as will be described more fully below, may be used, in conjunction with information provided by WD 120, to effect a particular transaction. It should be noted that examples described herein are primarily focused on a financial transaction that may, for example, be initiated within a store environment. However, those skilled in the art will appreciate that in-store gateway 140 need not be limited to store or commercial transactions, but may also be utilized for non-commercial purposes, and, as such, not necessarily deployed in, or even in communication, with a store.

Authentication system 150 may be part of in-store gateway 140 (as indicated by the broken line surrounding those two components, and collectively referred to as host 155), or may be a distinct component that is in communication with in-store gateway 140 via network 110. Authentication system 150 is, in the instant example implementation, configured to authenticate, e.g., confirm, that WD 120 has, in fact, supplied information sufficient to proceed with a given transaction (financial or otherwise). Authentication system 150 may also be used to authenticate a user 50 to ensure that user 50 is an authorized user of WD 120. Such authentication may be via password, challenge question, biometric identification (e.g., fingerprint, retina, voice, etc.), among others.

Those skilled in the relevant art will appreciate that gateway 140 (or host 155) may reside or be deployed in a cloud computing environment, be part of POS terminal 130, or be part of a third-party system.

Financial institution 160 may be a bank, clearinghouse, etc. that is configured to complete, clear or close a financial transaction by debiting/crediting selected accounts, transferring funds, etc.

Security control element 170 may be a security office responsible for, e.g., physical plant security, e.g., door access, safe access, etc.

As indicated, the foregoing elements are interconnected with each other via network 110 such that any one of the foregoing components may exchange data with any other indicated component using well-known Internet communication techniques. For example, each component may be assigned a unique logical Internet Protocol (IP) address and unique media access control (MAC) address such that network 110 can route data traffic to and from any component.

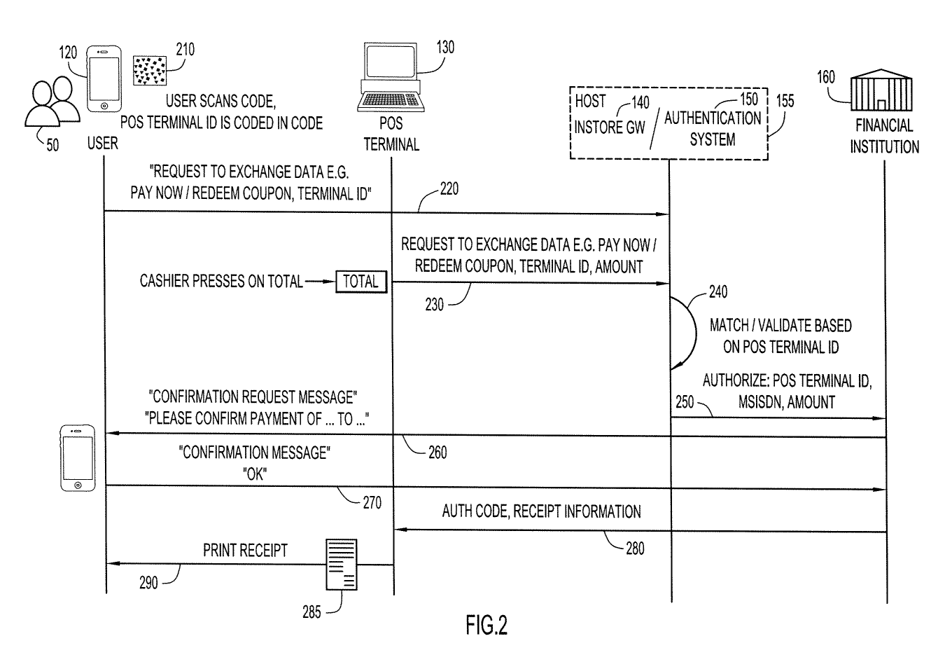

Reference is now made to FIG. 2, which illustrates portions of a payment transaction that leverages in-store gateway 140 in accordance with embodiments described herein. As part of inter alia a payment transaction, a user 50 may employ WD 120 to scan, photograph, etc. an artifact 210 associated with POS terminal 130. Among other things, artifact 210 (such as a bar code, a QR code, a sign, NFC tag, etc.) may be displayed near, affixed to, etc., POS terminal 130. Such an artifact may include inter alia a destination address (such as a Telephone Number (TN), a Short Code (SC), etc.) of a host, processing, verification, etc. system (e.g., in-store gateway 140 or host 155), an identifier of POS terminal 130 (such as a Merchant identifier), etc.

Software operating on, in, etc. WD 120 may process, decode, etc. artifact 210 and possibly inter alia dispatch information such as, e.g. details obtained from artifact 210 (destination address, identifier of POS terminal 130, etc.), WD user 50 identification (name, alias, etc.), WD 120 identification (TN, etc.), etc. to host 155. The foregoing is illustrated by process flow 220 wherein user 50, via WD 120, sends to in-store gateway 140 a message that includes an express or implied request to exchange data with in-store gateway 140 (although user 50 in fact may not know that the message being sent is being directed to such an entity). The message includes an indication to, e.g., pay now, redeem a coupon, etc. (i.e., an identifier of a type of transaction to be completed) and the identification of POS terminal 130. In one possible implementation, WD 120 includes an application that enables user 50 to select/identify the type of transaction.

In parallel with user 50 sending a message to in-store gateway 140, a merchant operating POS terminal 130 may be engaged to dispatch information (such as for example transaction particulars (transaction type identifier, description, price, etc.), merchant identification (name, alias, etc.), and identification of POS terminal 130, etc.) to in-store gateway 140 (or host 155), as indicated by message flow 230.

When in-store gateway 140 receives information from WD 120 and information from POS terminal 130 it may among other things, as indicated at 240, process that information; authenticate one or both of WD 120 and POS terminal 130; associate, correlate, etc. such received information using one or more values (such as for example identifiers of the merchant or POS terminal 130, etc.); alter, augment, enrich, etc. such received information; by itself, or by involving one or more other systems, complete a payment transaction; communicate with WD 120 and/or POS terminal 130 (to, e.g., secure additional information, secure further authorization, provide a status update, confirm completion of a payment transaction, etc.); etc. As indicated in FIG. 2, any authentication performed by in-store gateway 140 may be performed directly by that system element, or may be performed by or in conjunction with authentication system 150.

In connection with completing a payment transaction, in-store gateway 140 may engage financial institution 160 at message flow 250. More specifically, a message sent at message flow 250 may comprise, inter alia, an indication that the transaction is authorized (at least from the perspective of POS terminal 130 (and, e.g., a merchant operating the same), an identifier of POS terminal 130, an identifier of WD 120 (e.g., TN, Mobile Station International Subscriber Directory Number (MSISDN), etc.) and an amount associated with the transaction. Upon receipt by financial institution 160 of such a message via message flow 250, financial institution processes the same (including, e.g., checking for sufficient funds, placing a hold on an amount of money to cover the transaction, etc.) and generates a “confirmation request message” sent via message flow 260 to WD 120.

Such a confirmation request message in message flow 260 may include, e.g., language sufficient for user 50 to confirm that the transaction about to be closed is what is intended. For example, such a confirmation request message may include the wording “Please confirm payment of $110.23 to Merchant X.” In response to such a confirmation request message user 50, via WD 120, may send a “confirmation message” directly to financial institution 160. Such a confirmation message may include, simply, the word “OK” and be sent directly to financial institution 160 via wireless network 115 and through network 110. Upon receipt of the confirmation message from WD 120 via message flow 270, financial institution 160 may generate and send to POS terminal 130 an authorization code and receipt information (e.g., particulars of the transaction including transaction type and amount), as indicated by message flow to 280.

Such an authorization code may then trigger POS terminal 130 to generate and print an appropriate receipt 285 that can be provided to user 50 as indicated by flow 290. It is noted that while a paper receipt 285 is illustrated in FIG. 2, those skilled in the art will appreciate that POS terminal 130 could likewise send via network 110 an electronic version of receipt 285 to WD 120 or, e.g., an email address associated with the TN or MSISDN of WD 120.

From the foregoing series of exchanges, user 50 may be able to execute a cashless and paperless transaction employing only his WD 120.

The exchanges that were described above between WD 120 and other elements may take place through any number of mechanisms including for example Short Message Service (SMS)/Multimedia Message Service (MMS)/etc. messaging, Wireless Application Protocol (WAP), among others.

Further, the quanta of value that may be involved in a payment transaction as described above may include, inter alia, money, coupons, minutes (e.g., of airtime), credits (e.g., customer loyalty) points, mileage, etc.

The discussion that was presented above included TNs. However, it is to be understood that it would be readily apparent to one of ordinary skill in the relevant art that numerous other addresses or identifiers (such as possibly, inter alia, short codes (SCs, e.g., SMS short codes), Internet Protocol (IP) addresses, E-Mail addresses, Instant Messaging (IM) handles, Session Initiation Protocol (SIP) addresses, etc.) are easily possible and indeed are fully considered to be deployable in connection with implementations of the embodiments described herein.

The discussion that was presented above referenced messaging generally and particular messaging paradigms—SMS and MMS—specifically. However, as was noted previously, it will be readily apparent to one of ordinary skill in the relevant art that application of aspects of the described embodiments to numerous other communication paradigms (including inter alia a Voice over Internet Protocol (VoIP) data stream, software application data, a SIP-addressed artifact, a voice telephone call, an audio data stream, signaling and other command-and-control data, etc.) is easily possible and indeed may be deployed in connection with implementations of the embodiments described herein.

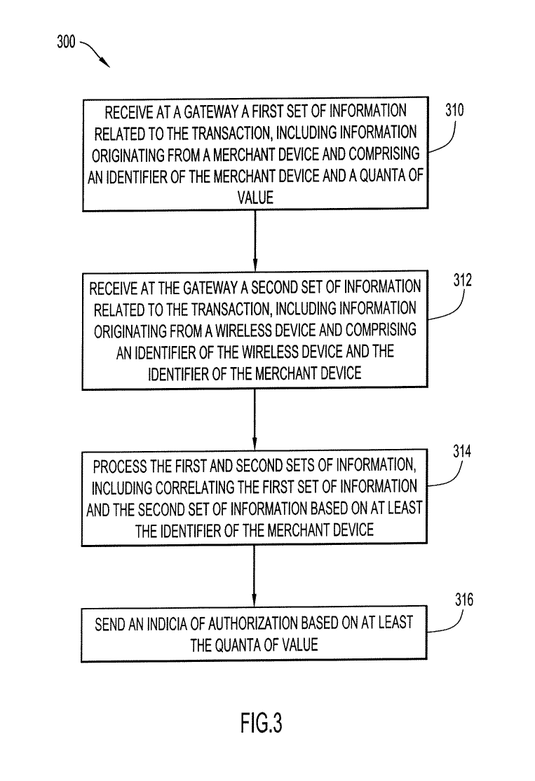

FIG. 3 depicts a flowchart illustrating a process 300 for effectuating a payment transaction using gateway 140 (or host 155) consistent with the foregoing discussion. At 310, the gateway receives a first set of information related to the transaction, the first set of information originating from a merchant device and comprising an identifier of the merchant device and a quanta of value. At 320, the gateway receives a second set of information related to the transaction, the second set of information originating from the wireless device and comprising an identifier of the wireless device and the identifier of the merchant device. At 330, the gateway (or host) processes the first and second sets of information, including correlating the first set of information and the second set of information based on at least the identifier of the merchant device, and at 340 the gateway sends an indicia of authorization based on at least the quanta of value. The indicia may be sent to, e.g., a financial institution for further processing.

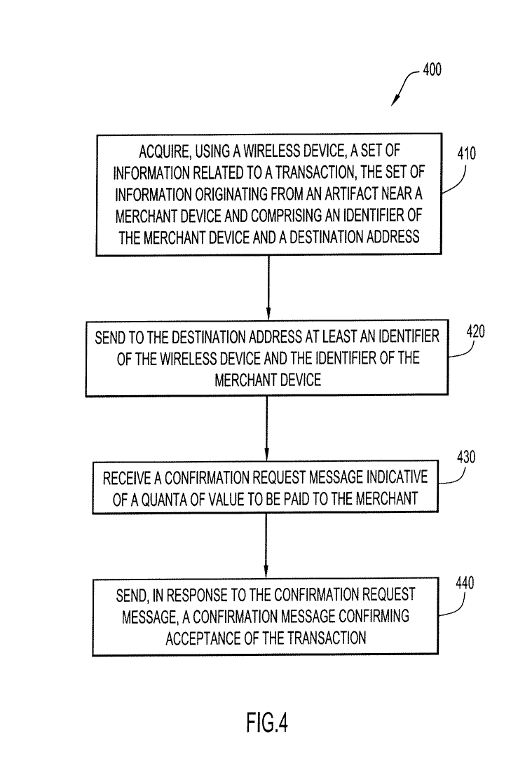

FIG. 4 depicts another flowchart illustrating another process 400 for effectuating a transaction in accordance with embodiments described herein. Process 400 may be considered to be operable from the perspective of WD 120. More specifically, at 410 the wireless device acquires a set of information related to the transaction, the set of information originating from an artifact near a merchant device and comprising an identifier of the merchant device and a destination address. At 420, the wireless device sends to the destination address at least an identifier of the wireless device and the identifier of the merchant device. At 430, the wireless device receives a confirmation request message indicative of a quanta of value to be paid to the merchant, and at 440 the wireless device sends, in response to the confirmation request message, a confirmation message confirming acceptance of the transaction.

The context of the above discussion was a payment transaction. It will be readily appreciated to one of ordinary skill in the relevant art that embodiments described herein could easily be employed within other contexts. For example, in connection with controlling physical access (to, for example, a door, a safe, a room, a building, etc.), user 50 of WD 120 may employ WD 120 to scan, photograph, etc. an entry system's artifact (sign, poster, QR code, etc.); software on, in, etc. WD 120 may process, decode, etc. the artifact and possibly inter alia dispatch information to the entry system (such as security control element 160); the entry system may complete one or more verification, confirmation, authentication, etc. steps (such as for example interacting with user 50 requesting access, taking a photograph of user 50 requesting access, etc.); and the entry system may then grant access.

Various aspects of the embodiments described herein can be implemented by software, firmware, hardware, or any combination thereof. FIG. 5 illustrates an example computer system 500 which may be employed for any one of WD 120, POS terminal 130, in-store gateway 140, financial institution 160 and/or security control element 170, or portions thereof, in combination with, e.g., computer-readable code. After reading the foregoing description, it will become apparent to a person skilled in the relevant art how to implement the embodiments described herein using other computer systems and/or computer architectures.

Computer system 500 includes one or more processors, such as processor 504. Processor 504 can be a special purpose processor or a general purpose processor. Processor 504 is connected to a communication infrastructure 502 (for example, a bus or a network).

Computer system 500 also includes a main memory 506, preferably Random Access Memory (RAM), containing possibly inter alia computer software and/or data 508.

Computer system 500 may also include a secondary memory 510. Secondary memory 510 may include, for example, a hard disk drive 512, a removable storage drive 514, a memory stick, etc. A removable storage drive 514 may comprise a floppy disk drive, a magnetic tape drive, an optical disk drive, a flash memory, or the like. A removable storage drive 514 reads from and/or writes to a removable storage unit 516 in a well known manner. A removable storage unit 516 may comprise a floppy disk, magnetic tape, optical disk, etc. which is read by and written to by removable storage drive 514. As will be appreciated by persons skilled in the relevant art(s) removable storage unit 516 includes a computer usable storage medium 518 having stored therein possibly inter alia computer software and/or data 520.

In alternative implementations, secondary memory 510 may include other similar means for allowing computer programs or other instructions to be loaded into computer system 500. Such means may include, for example, a removable storage unit 524 and an interface 522. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 524 and interfaces 522 which allow software and data to be transferred from the removable storage unit 524 to computer system 500.

Computer system 500 may also include an input interface 526 and a range of input devices 528 such as, possibly inter alia, a keyboard, a mouse, etc.

Computer system 500 may also include an output interface 530 and a range of output devices 532 such as, possibly inter alia, a display, one or more speakers, etc.

Computer system 500 may also include a communications interface 534. Communications interface 534 allows software and/or data 538 to be transferred between computer system 500 and external devices. Communications interface 534 may include a modem, a network interface (such as an Ethernet card), a communications port, a Personal Computer Memory Card International Association (PCMCIA) slot and card, or the like. Software and/or data 538 transferred via communications interface 534 are in the form of signals 936 which may be electronic, electromagnetic, optical, or other signals capable of being received by communications interface 534. These signals 536 are provided to communications interface 534 via a communications path 540. Communications path 540 carries signals and may be implemented using wire or cable, fiber optics, a phone line, a cellular phone link, a Radio Frequency (RF) link or other communications channels.

As used in this document, the terms “computer program medium,” “computer usable medium,” and “computer readable medium” generally refer to media such as removable storage unit 516, removable storage unit 524, and a hard disk installed in hard disk drive 512. Signals carried over communications path 540 can also embody the logic described herein. Computer program medium and computer usable medium can also refer to memories, such as main memory 906 and secondary memory 510, which can be memory semiconductors (e.g. Dynamic Random Access Memory (DRAM) elements, etc.). These computer program products are means for providing software to computer system 500.

Computer programs (also called computer control logic) are stored in main memory 506 and/or secondary memory 510. Computer programs may also be received via communications interface 534. Such computer programs, when executed, enable computer system 500 to implement the functionality of the embodiments discussed herein. In particular, the computer programs, when executed, enable processor 504 to implement the processes described above. Accordingly, such computer programs represent controllers of the computer system 500. Where the described embodiments are implemented using software, the software may be stored in a computer program product and loaded into computer system 500 using removable storage drive 514, interface 522, hard drive 512 or communications interface 534.

The described embodiments are also directed to computer program products comprising software stored on any computer useable medium. Such software, when executed in one or more data processing devices, causes data processing device(s) to operate as described herein. Embodiments can employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), nanotechnological storage device, etc.), and communication mediums (e.g., wired and wireless communications networks, local area networks, wide area networks, intranets, etc.).

It is important to note that the hypothetical examples that were presented above, which were described in the narrative and which were illustrated in the accompanying figures, are exemplary only. They are not intended to be exhaustive or to limit the described embodiments to the specific forms disclosed. It will be readily apparent to one of ordinary skill in the relevant art that numerous alternatives to the presented examples are easily possible.

What is claimed is:

1. A method within a gateway for facilitating a payment portion of a transaction, the transaction involving a merchant and a user of a wireless device, the method comprising:
receiving at the gateway a first set of information related to the transaction, the first set of information originating from a merchant device and comprising an identifier of the merchant device and a quanta of value;
receiving at the gateway a second set of information related to the transaction, the second set of information originating from the wireless device and comprising an identifier of the wireless device and the identifier of the merchant device;
processing the first and second sets of information, including correlating the first set of information and the second set of information based on at least the identifier of the merchant device; and
sending an indicia of authorization based on at least the quanta of value.

2. The method of claim 1, wherein the merchant device is one of (a) a Point of Sale (POS) system, (b) a cash register, (c) a payment system, (d) a coupon system, (e) a ticketing system, (f) a parking station, (g) a vending machine, (h) a fuel station system or (i) a computer.

3. The method of claim 1, wherein the gateway resides in one or more of (a) a cloud, (b) the merchant device, and/or (c) a third-party system.

4. The method of claim 1, wherein the quanta of value comprises one or more of (a) an amount of money, (b) a coupon, (c) minutes of airtime, (d) credits, (e) points, and/or (f) mileage.

5. The method of claim 1, wherein sending employs one or more of (a) a Short Message Service (SMS) message, (b) a Multimedia Message Service (MMS) message, (c) a Wireless Application Protocol (WAP) exchange, and/or (d) a data service.

6. The method of claim 1, wherein the first set of information includes an identifier of a type of the transaction.

7. The method of claim 1, further comprising receiving, at the merchant device, an authorization code that is employed to generate a receipt for the user of the wireless device.

8. The method of claim 7, further comprising printing the receipt for delivery to the user of the wireless device.

9. The method of claim 7, further comprising sending an electronic version of the receipt to the wireless device or an account associated with an identifier of the wireless device.

10. A method within a wireless device for facilitating a payment portion of a transaction, the transaction comprising a merchant and a user of the wireless device, the method comprising:
acquiring, using the wireless device, a set of information related to the transaction, the set of information originating from an artifact near a merchant device and comprising an identifier of the merchant device and a destination address;
sending, via the wireless device, to the destination address at least an identifier of the wireless device and the identifier of the merchant device;
receiving, at the wireless device, a confirmation request message indicative of a quanta of value to be paid to the merchant; and
sending, via the wireless device, in response to the confirmation request message, a confirmation message confirming acceptance of the transaction.

11. The method of claim 10, wherein the merchant device is one of (a) a Point of Sale (POS) system, (b) a cash register, (c) a payment system, (d) a coupon system, (e) a ticketing system (f) a parking station, (g) a vending machine, (h) a fuel station system, or (i) a computer.

12. The method of claim 10, wherein the artifact is one or more of (a) a sign, (b) a bar code, (c) a Near Field Communication (NFC) tag, and/or (d) a Quick Response (QR) code.

13. The method of claim 10, wherein the acquisition of the set of information is through one or more of (a) a scan operation (b) manual input and/or (c) a photograph.

14. The method of claim 10, wherein the quanta of value comprises one or more of (a) an amount of money, (b) a coupon, (c) an amount of time, (d) a credit, (e) a point, and/or (f) mileage.

15. The method of claim 10, wherein the destination address is one or more of (a) a telephone number, (b) a short code and/or (c) a universal resource locator (URL).

16. The method of claim 10, wherein sending and receiving employ one or more of (a) a Short Message Service (SMS) message, (b) a Multimedia Message Service (MMS) message, (c) a Wireless Application Protocol (WAP) exchange, and/or (d) a data service.

17. The method of claim 10, further comprising sending, via the wireless device, to the destination address an identifier of a type of the transaction.

18. The method of claim 10, further comprising receiving a receipt indicative of the transaction.

19. The method of claim 18, further comprising receiving a printed receipt.

20. The method of claim 18, further comprising receiving an electronic version of the receipt at the wireless device or an account associated with an identifier of the wireless device.

21. A method within a merchant device for facilitating a payment portion of a transaction, the transaction comprising a merchant and a user of the wireless device, the method comprising:
exhibiting an artifact near the merchant device which comprises an identifier of the merchant device;
sending, via the merchant device, to a destination address of a gateway, at least an identifier of the merchant device and a quanta of value to be paid to the merchant;
receiving, at the merchant device, in response to the request message, an authorization code indicative of acceptance of the transaction.

22. The method of claim 21, wherein the merchant device is one of (a) a Point of Sale (POS) system, (b) a cash register, (c) a payment system, (d) a coupon system, (e) a ticketing system, (f) a parking station, (g) a vending machine, (h) fuel station system (pay at pump), or (i) a computer.

23. The method of claim 21, wherein the artifact is one or more of (a) a sign, (b) a bar code, (c) a Near Field Communication (NFC) tag, and/or (d) a Quick Response (QR) code

24. The method of claim 21, wherein the sending is invoked by either (a) a cashier or (b) the user of the wireless device.

25. The method of claim 21, wherein the quanta of value comprises one or more of (a) an amount of money/monetary value, (b) a coupon, (c) an amount of time, (d) a credit, (e) a point, and/or (f) mileage.

26. The method of claim 21, wherein the set of information includes an identifier of a type of the transaction.

27. The method of claim 21, further comprising receiving an authorization code that is employed to generate a receipt for the user of the wireless device.

28. The method of claim 27, further comprising generating and printing a receipt indicative of the transaction.

29. The method of claim 27, further comprising sending an electronic version of the receipt to the destination address of the gateway.
